(19) United States
(12) Patent Application Publication
(10) Pub. No.: US 2024/0034431 A1
(43) Pub. Date: Feb. 1, 2024

(54) CONTROL DEVICE FOR HUMAN-POWERED VEHICLE

(71) Applicant: Shimano Inc., Osaka (JP)

(72) Inventor: Satoshi SHAHANA, Osaka (JP)

(21) Appl. No.: 18/220,525

(22) Filed: Jul. 11, 2023

(30) Foreign Application Priority Data
Jul. 28, 2022 (JP) 2022-120150

(51) Int. Cl. B62M 6/45; B62M 25/08

(52) U.S. Cl. CPC B62M 6/45; B62M 25/08

(57) ABSTRACT

A control device for a human-powered vehicle includes an electronic controller. The human-powered vehicle includes a crank axle that receives a human driving force, a first rotational body connected to the crank axle, a wheel, a second rotational body connected to the wheel, a transmission body engaged with the rotational bodies to transmit a driving force between the rotational bodies, a derailleur that operates the transmission body to shift a transmission ratio, and a motor that drives the transmission body. The electronic controller controls the motor to drive the transmission body with the motor without propelling the human-powered vehicle with the driving force of the motor in a case where a first condition in which the crank axle is rotated and the human-powered vehicle is propelled without the human driving force and a shifting condition for shifting the transmission ratio with the derailleur are satisfied.

### CROSS-REFERENCE TO RELATED APPLICATIONS

This application claims priority to Japanese Patent Application No. 2022-120150, filed on Jul. 28, 2022. The entire disclosure of Japanese Patent Application No. 2022-120150 is hereby incorporated herein by reference.

### BACKGROUND

### Technical Field

The present disclosure generally relates to a control device for a human-powered vehicle.

### Background Information

One example of a control device for a human-powered vehicle is disclosed in Japanese Patent No. 5686876. In this Japanese patent, the control device is configured to drive a transmission body with a motor and operate the transmission body with a derailleur to perform a shifting operation for shifting a transmission ratio in a case where rotation of a crank axle is stopped.

### SUMMARY

An objective of the present disclosure is to provide a control device for a human-powered vehicle that drives a motor so as to allow for optimal shifting operations with a derailleur.

A control device in accordance with a first aspect of the present disclosure is for a human-powered vehicle. The human-powered vehicle includes a crank axle, a first rotational body, a wheel, a second rotational body, a transmission body, a derailleur, and a motor. The crank axle is configured to receive a human driving force. The first rotational body is connected to the crank axle. The second rotational body is connected to the wheel. The transmission body is engaged with the first rotational body and the second rotational body to transmit a driving force between the first rotational body and the second rotational body. The derailleur is configured to operate the transmission body to shift a transmission ratio of a rotational speed of the wheel to a rotational speed of the crank axle. The motor is configured to drive the transmission body. The control device comprises an electronic controller. The electronic controller is configured to control the motor so as to drive the transmission body with the motor without propelling the human-powered vehicle with the driving force of the motor in a case where a first condition in which the crank axle is rotated and the human-powered vehicle is propelled without human driving force and a shifting condition for shifting the transmission ratio with the derailleur are satisfied. With the control device according to the first aspect, in a case where the crank axle is rotated, the human-powered vehicle is propelled without human driving force, and the shifting condition is satisfied, the electronic controller drives the transmission body with the driving force of the motor that is insufficient for propelling the human-powered vehicle. In this manner, the control device drives the motor so as to allow for optimal shifting operations with the derailleur.

In accordance with a second aspect of the present disclosure, the control device according to the first aspect is configured so that the human-powered vehicle further includes a first detector that detects a parameter related to a rotational speed of the crank axle and a second detector that detects a parameter related to a rotational speed of the wheel. The first condition includes a condition in which the rotational speed of the crank axle obtained from the detection of the first detector is greater than zero and a condition in which the rotational speed of the crank axle is less than or equal to an estimated rotational speed calculated from the transmission ratio and the rotational speed of the wheel obtained from the detection of the second detector. With the control device according to the second aspect, in a case where the rotational speed of the crank axle is greater than zero, the rotational speed of the crank axle is less than or equal to the estimated rotational speed calculated from the rotational speed of the wheel and the transmission ratio, and the shifting condition is satisfied, the electronic controller drives the transmission body with the driving force of the motor that is insufficient for propelling the human-powered vehicle. In a case where the human-powered vehicle is propelled without the human driving force, the rotational speed of the crank axle obtained from the detection of the first detector is less than or equal to the estimated rotational speed calculated from the rotational speed of the wheel obtained from the detection of the second detector. Thus, the electronic controller determines whether the human-powered vehicle is propelled without the human driving force based on if the rotational speed of the crank axle is less than or equal to the estimated rotational speed. With the control device according to the second aspect, in a case where the human-powered vehicle is propelled without the human driving force, the control device drives the motor so as to allow for an optimal shifting operation with the derailleur.

In accordance with a third aspect of the present disclosure, the control device according to the first or second aspect is configured so that in a case where the first condition and the shifting condition are satisfied and the motor is driven, the electronic controller is configured to stop the motor upon a stopping condition of the motor being satisfied. The stopping condition includes at least one of a first stopping condition in which a predetermined period elapses from when driving of the motor is started and a second stopping condition in which a load on the motor is greater than or equal to a first threshold value. With the control device according to the third aspect, in a state in which the first condition and the shifting condition are satisfied and the motor is driven, the control device stops the motor in at least one of a case where the predetermined period elapses from when driving of the motor is started and a case where the load on the motor is greater than or equal to the first threshold value.

In accordance with a fourth aspect of the present disclosure, the control device according to the third aspect is configured so that the predetermined period includes at least one of a predetermined time, a period during which an output shaft of the motor is rotated more than a first rotational angle, and a period during which the first rotational body is rotated by the motor over a second rotational angle. With the control device according to the fourth aspect, in a state in which the first condition and the shifting condition are satisfied and the motor is driven, the control device stops the motor in a case where at least one of the predetermined time, the period during which the output shaft of the motor is rotated more than the first rotational angle, and the period during which the first rotational body is rotated by the motor over the second rotational angle elapses from when driving of the motor is started.

In accordance with a fifth aspect of the present disclosure, the control device according to any one of the first to fourth aspects is configured so that the electronic controller is configured to control the derailleur. The electronic controller is configured to drive the transmission body with the motor and operate the transmission body with the derailleur in a case where the first condition and the shifting condition are satisfied. With the control device according to the fifth aspect, in a case where the first condition and the shifting condition are satisfied, the electronic controller drives the transmission body with the motor and operates the transmission body with the derailleur. Thus, the control device shifts the transmission ratio in a preferred manner.

In accordance with a sixth aspect of the present disclosure, the control device according to any one of the first to fifth aspects is configured so that the electronic controller is configured to drive the transmission body with the motor without propelling the human-powered vehicle with the driving force of the motor and operate the transmission body with the derailleur in a case where a second condition and the shifting condition are satisfied. The second condition is satisfied in a case where rotation of the crank axle is stopped. With the control device according to the sixth aspect, in a case where rotation of the crank axle is stopped and the shifting condition is satisfied, the electronic controller drives the transmission body with the motor and operates the transmission body with the derailleur. This shifts the transmission ratio in a preferred manner.

In accordance with a seventh aspect of the present disclosure, the control device according to the first aspect is configured so that the human-powered vehicle further includes a first detector that detects a parameter related to a rotational speed of the crank axle and a third detector that detects a parameter related to a human torque that is input to the crank axle of the human-powered vehicle. The first condition is satisfied in a case where the rotational speed of the crank axle obtained from a detection value of the first detector is greater than zero and the human torque obtained from a detection value of the third detector is less than or equal to a predetermined torque. The predetermined torque is 0 Nm or greater and 5 Nm or less. With the control device according to the seventh aspect, in a case where the rotational speed of the crank axle is greater than zero, the human torque is 0 Nm or greater and 5 Nm or less, and the shifting condition is satisfied, the electronic controller drives the transmission body with the driving force of the motor that is insufficient for propelling the human-powered vehicle. In this manner, the control device drives the motor so as to allow for optimal shifting operations with the derailleur.

A control device in accordance with an eighth aspect of the present disclosure is for a human-powered vehicle. The human-powered vehicle includes a crank axle, a first rotational body, a wheel, a second rotational body, a transmission body, a derailleur, and a motor. The crank axle is configured to receive a human driving force. The first rotational body is connected to the crank axle. The second rotational body is connected to the wheel. The transmission body is engaged with the first rotational body and the second rotational body to transmit a driving force between the first rotational body and the second rotational body. The derailleur is configured to operate the transmission body to shift a transmission ratio of a rotational speed of the wheel to a rotational speed of the crank axle. The motor is configured to drive the transmission body. The control device comprises an electronic controller. The electronic controller is configured to control the motor and the derailleur. In a case where a shifting condition for shifting the transmission ratio with the derailleur is satisfied, the electronic controller is configured to drive the transmission body with the motor without propelling the human-powered vehicle with the driving force of the motor and operate the transmission body with the derailleur to shift the transmission ratio regardless of the rotational speed of the crank axle. With the control device according to the eighth aspect, the electronic controller drives the transmission body with the driving force of the motor that is insufficient for propelling the human-powered vehicle and operates the transmission body with the derailleur in a case where the shifting condition is satisfied regardless of the rotational speed of the crank axle. In this manner, the control device drives the motor so as to allow for optimal shifting operations with the derailleur.

In accordance with a ninth aspect of the present disclosure, the control device according to the eighth aspect is configured so that in a case where the shifting condition is satisfied and the motor is driven, the electronic controller is configured to stop driving the motor upon a stopping condition of the motor being satisfied. The stopping condition includes at least one of a first stopping condition in which a predetermined period elapses from when driving of the motor is started and a second stopping condition in which a load on the motor is greater than or equal to a first threshold value. With the control device according to the ninth aspect, in a case where the shifting condition is satisfied and the motor is driven, the control device stops the motor in at least one of a case where the predetermined period elapses from when driving of the motor is started and a case where the load on the motor is greater than or equal to the first threshold value.

In accordance with a tenth aspect of the present disclosure, the control device according to the ninth aspect is configured so that the predetermined period includes at least one of a predetermined time, a period during which an output shaft of the motor is rotated more than a first rotational angle, and a period during which the first rotational body is rotated by the motor more than a second rotational angle. With the control device according to the tenth aspect, in a state in which the shifting condition is satisfied and the motor is driven, the control device stops the motor in a case where at least one of the predetermined time, the period during which the output shaft of the motor is rotated more than the first rotational angle, and the period during which the first rotational body is rotated by the motor more than the second rotational angle elapses from when driving of the motor is started.

A control device in accordance with an eleventh aspect of the present disclosure is for a human-powered vehicle. The human-powered vehicle includes a crank axle, a first rotational body, a wheel, a second rotational body, a transmission body, a derailleur, and a motor. The crank axle is configured to receive a human driving force. The first rotational body is connected to the crank axle. The second rotational body is connected to the wheel. The transmission body is engaged with the first rotational body and the second rotational body to transmit a driving force between the first rotational body and the second rotational body. The derailleur is configured to operate the transmission body to shift a transmission ratio of a rotational speed of the wheel to a rotational speed of the crank axle. The motor is configured to drive the transmission body. The control device comprises an electronic controller. The electronic controller is configured to control the motor so as to drive the transmission body with the motor and propel the human-powered vehicle with the driving force of the motor in a case where a third condition and a shifting condition for shifting the transmission ratio with the derailleur are satisfied. The third condition includes a condition related to a speed of the human-powered vehicle. With the control device according to the eleventh aspect, in a case where the condition related to the speed of the human-powered vehicle and the shifting condition are satisfied, the electronic controller drives the transmission body with the driving force of the motor that propels the human-powered vehicle. In this manner, the control device drives the motor so as to allow for optimal shifting operations with the derailleur.

In accordance with a twelfth aspect of the present disclosure, the control device according to the eleventh aspect is configured so that the third condition is satisfied in a case where the speed of the human-powered vehicle is increased. With the control device according to the twelfth aspect, in a case where the speed of the human-powered vehicle is increased and the shifting condition is satisfied, the electronic controller drives the transmission body with the driving force of the motor that propels the human-powered vehicle. In this manner, the control device drives the motor so as to allow for optimal shifting operations with the derailleur.

In accordance with a thirteenth aspect of the present disclosure, the control device according to the eleventh or twelfth aspect is configured so that in a case where the third condition and the shifting condition are satisfied and the motor is thereby driven to apply a propulsion force to the human-powered vehicle, the electronic controller is configured to control the motor so as to stop driving the motor upon a stopping condition being satisfied. The stopping condition includes at least one of a first stopping condition in which a predetermined period elapses from when driving of the motor is started and a second stopping condition in which a load on the motor is greater than or equal to a first threshold value. With the control device according to the thirteenth aspect, in a state in which the third condition and the shifting condition are satisfied and the motor is driven, the control device stops the motor in at least one of a case where the predetermined period elapses from when driving of the motor is started and a case where the load on the motor is greater than or equal to the first threshold value.

In accordance with a fourteenth aspect of the present disclosure, the control device according to the thirteenth aspect is configured so that the predetermined period includes at least one of a predetermined time, a period during which an output shaft of the motor is rotated more than a first rotational angle, and a period during which the first rotational body is rotated by the motor more than a second rotational angle. With the control device according to the fourteenth aspect, in a state in which the first condition and the shifting condition are satisfied and the motor is driven, the control device stops the motor in a case where at least one of the predetermined time, the period during which the output shaft of the motor is rotated more than the first rotational angle, and the period during which the first rotational body is rotated by the motor more than the second rotational angle elapses from when driving of the motor is started.

In accordance with a fifteenth aspect of the present disclosure, the control device according to any one of the first to fourteenth aspects is configured so that the shifting condition is related to at least one of a traveling state of the human-powered vehicle, a traveling environment of the human-powered vehicle, and an operating state of a shifting device of the human-powered vehicle. The control device according to the fifteenth aspect shifts the transmission ratio in accordance with at least one of the traveling state of the human-powered vehicle, the traveling environment of the human-powered vehicle, and the operating state of the shifting device of the human-powered vehicle.

The control device for the human-powered vehicle of the present disclosure drives the motor so as to allow for optimal shifting operations with the derailleur.

### BRIEF DESCRIPTION OF THE DRAWINGS

Referring now to the attached drawings which form a part of this original disclosure.

FIG. 1 is a side elevational view of a human-powered vehicle including a human-powered vehicle control device in accordance with a first embodiment.

FIG. 2 is a block diagram showing the electrical configuration of the human-powered vehicle shown in FIG. 1.

FIG. 3 is a cross-sectional view of a drive unit for the human-powered vehicle shown in FIG. 1.

FIG. 4 is a flowchart illustrating a control process executed by an electronic controller shown in FIG. 2 to control a motor and a derailleur.

FIG. 5 is a flowchart illustrating a control process executed by an electronic controller in accordance with a second embodiment to control a motor and a derailleur.

FIG. 6 is a flowchart illustrating a control process executed by an electronic controller in accordance with a third embodiment to control a motor and a derailleur.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

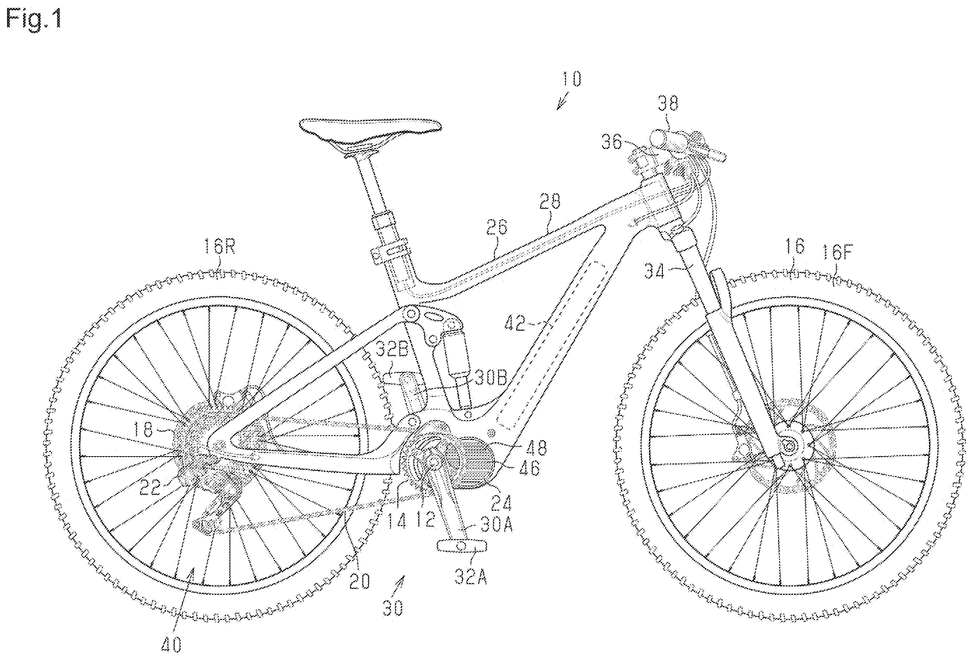

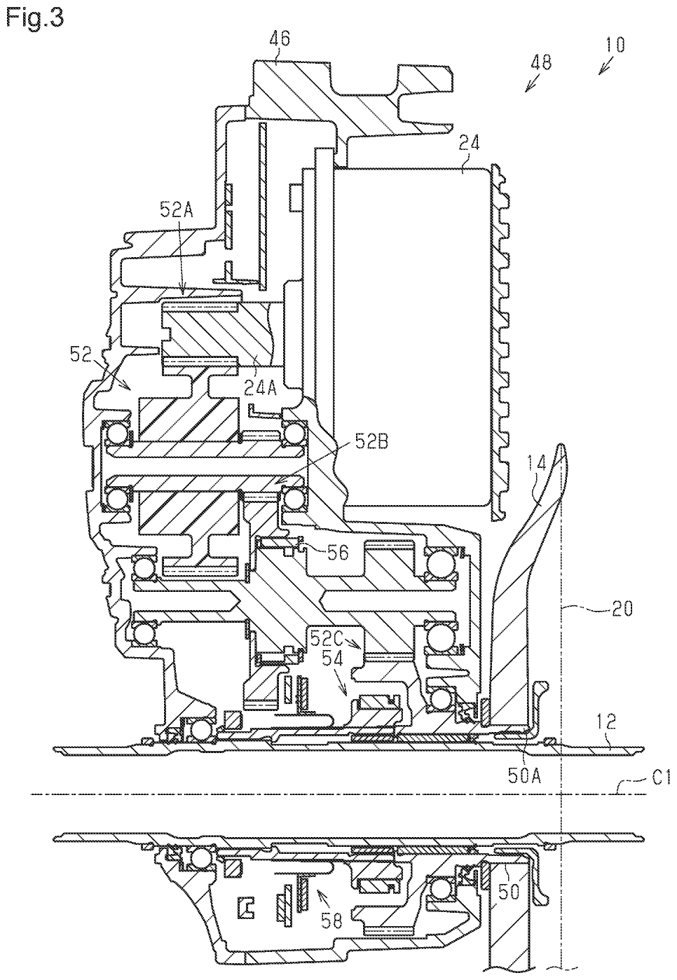

A control device 70 for a human-powered vehicle will now be described with reference to FIGS. 1 to 4. A human-powered vehicle is a vehicle that includes at least one wheel and can be driven by at least a human driving force. Examples of the human-powered vehicle include various types of bicycles such as a mountain bike, a road bike, a city bike, a cargo bike, a handcycle, and a recumbent bike. There is no limit to the number of wheels of the human-powered vehicle. The human-powered vehicle also includes, for example, a unicycle or a vehicle having two or more wheels. The human-powered vehicle is not limited to a vehicle that can be driven only by a human driving force. The human-powered vehicle includes an electric bicycle (E-bike) that uses drive force of an electric motor for propulsion in addition to the human driving force. The E-bike includes an electric assist bicycle that assists in propulsion with an electric motor. In each embodiment described hereafter, the human-powered vehicle will be described as a bicycle.

A human-powered vehicle 10 includes a crank axle 12, a first rotational body 14, a wheel 16, a second rotational body 18, a transmission body 20, a derailleur 22, and a motor 24. The crank axle 12 is configured to receive a human driving force. The first rotational body 14 is connected to the crank axle 12. The second rotational body 18 is connected to the wheel 16. The transmission body 20 is engaged with the first rotational body 14 and the second rotational body 18 to transmit a driving force between the first rotational body 14 and the second rotational body 18.

The human-powered vehicle 10 further includes, for example, a vehicle body 26. The vehicle body 26 includes, for example, a frame 28. A saddle is provided on the frame 28. The wheel 16 includes, for example, a front wheel 16F and a rear wheel 16R. The crank axle 12 is, for example, rotatable relative to the frame 28. The human-powered vehicle 10 includes, for example, a crank 30. The crank 30 includes the crank axle 12 and crank arms 30A and 30B.

The crank arm 30A is, for example, provided on a first axial end of the crank axle 12, and the crank arm 30B is provided on a second axial end of the crank axle 12. The human-powered vehicle 10 includes, for example, a pair of pedals 32A and 32B. The pedal 32A is, for example, coupled to the crank arm 30A. The pedal 32B is, for example, coupled to the crank arm 30B. The rear wheel 16R is, for example, driven by rotation of the crank axle 12. The rear wheel 16R is, for example, supported by the frame 28. The front wheel 16F is attached to the frame 28 by a front fork 34. A handlebar 38 is coupled to the front fork 34 by a stem 36.

The human-powered vehicle 10 further includes, for example, a drive mechanism 40. For example, the drive mechanism 40 connects at least one of the front wheel 16F and the rear wheel 16R is to the crank 30. In the present embodiment, the drive mechanism 40 connects the rear wheel 16R to the crank 30.

The drive mechanism 40 includes, for example, the first rotational body 14, the second rotational body 18, and the transmission body 20. The first rotational body 14 is connected to the crank axle 12. The second rotational body 18 is connected to the wheel 16. The transmission body 20 is engaged with the first rotational body 14 and the second rotational body 18 to transmit the driving force between the first rotational body 14 and the second rotational body 18. The transmission body 20 is, for example, configured to transmit rotational force of the first rotational body 14 to the second rotational body 18.

The first rotational body 14 is, for example, arranged coaxially with the crank axle 12. The first rotational body 14 does not have to be arranged coaxially with the crank axle 12. In a case where the first rotational body 14 is not arranged coaxially with the crank axle 12, the first rotational body 14 is, for example, connected to the crank axle 12 by a first transmission mechanism. The first transmission mechanism can include a set of gears, a set of sprockets and a chain, a set of pulleys and a belt, or a set of shafts and bevel gears. The first rotational body 14 includes, for example, at least one first sprocket or at least one first pulley.

The second rotational body 18 is, for example, arranged coaxially with the rear wheel 16R. The second rotational body 18 does not have to be arranged coaxially with the rear wheel 16R. In a case where the second rotational body 18 is not arranged coaxially with the rear wheel 16R, the second rotational body 18 is, for example, connected to the rear wheel 16R by a second transmission mechanism. The second transmission mechanism can include a set of gears, a set of sprockets and a chain, a set of pulleys and a belt, or a set of shafts and bevel gears. The second rotational body 18 includes, for example, at least one second sprocket or at least one second pulley.

The second rotational body 18 is, for example, connected to the rear wheel 16R by a first one-way clutch. The first one-way clutch includes, for example, at least one of a roller clutch, a sprag clutch, and a ratchet clutch. The first one-way clutch is configured to transmit the driving force from the second rotational body 18 to the rear wheel 16R in a case where the second rotational body 18 is rotated in accordance with a forward rotation of the first rotational body 14. Further, the first one-way clutch is configured to allow relative rotation of the rear wheel 16R and the second rotational body 18 in a case where the speed at which the rear wheel 16R is rotated forward is higher than the speed at which the second rotational body 18 is rotated forward.

The human-powered vehicle 10 further includes, for example, a battery 42. The battery 42 includes one or more battery cells. Each battery cell includes a rechargeable battery. The battery 42 is, for example, configured to supply electric power to the control device 70 and the motor 24. The battery 42 is, for example, connected to the control device 70 in a manner allowing for wired communication or wireless communication. The battery 42 is configured to establish communication with the control device 70 through, for example, power line communication (PLC), Controller Area Network (CAN), or universal asynchronous receiver/transmitter (UART).

The derailleur 22 is configured to operate the transmission body 20 to shift a transmission ratio of a rotational speed of the wheel 16 to a rotational speed of the crank axle 12. The transmission ratio is, for example, a ratio of the rotational speed of the wheel 16 to the rotational speed of the crank axle 12. The rotational speed of the wheel 16 includes, for example, the rotational speed of the drive wheel.

The derailleur 22 includes, for example, at least one of a front derailleur and a rear derailleur. In a case where the derailleur 22 includes at least one of a front derailleur and a rear derailleur, the transmission body 20 includes a chain. The transmission body 20 can include a belt.

The derailleur 22 moves, for example, the transmission body 20 from a position engaged with one of sprockets to a position engaged with another one of the sprockets. The derailleur 22 includes, for example, an electric actuator 44. The electric actuator 44 is, for example, configured to actuate the derailleur 22.

The derailleur 22 is, for example, provided in a transmission path of the human driving force in the human-powered vehicle 10, and is configured to shift the transmission ratio. The derailleur 22 shifts the transmission ratio by, for example, operating the transmission body 20 and changing the engagement state of the transmission body 20 and at least one of the first rotational body 14 and the second rotational body 18. The relationship of the transmission ratio, the rotational speed of the wheel 16, and the rotational speed of the crank axle 12 satisfies the following equation (1). In equation (1), the term “R” represents the transmission ratio. In equation (1), the term “W” represents the rotational speed of the wheel 16. In equation (1), the term “C” represents the rotational speed of the crank axle 12.

R=W (rpm)/C (rpm) Equation (1):

The derailleur 22 can shift the transmission ratio in accordance with, for example, at least one transmission stage. The derailleur 22 is, for example, configured to operate the transmission body 20 and shift the at least one transmission stage. The at least one transmission stage is, for example, set in accordance with at least one of the first rotational body 14 and the second rotational body 18. In an example in which the at least one transmission stage includes more than one transmission stage, a different transmission ratio is set to each transmission stage. For example, the transmission ratio becomes greater as the transmission stage increases.

In a case where the first rotational body 14 includes more than one first sprocket, and the second rotational body 18 includes more than one second sprocket, the transmission stage is set in accordance with, for example, a combination of one of the first sprockets and one of the second sprockets. In a case where the first rotational body 14 includes one first sprocket, and the second rotational body 18 includes more than one second sprocket, the transmission stage is set in accordance with, for example, a combination of the one first sprocket and one of the second sprockets. In a case where the first rotational body 14 includes more than one first sprocket, and the second rotational body 18 includes one second sprocket, the transmission stage is set in accordance with, for example, a combination of one of the first sprockets and the one second sprocket.

The derailleur 22 moves, for example, the chain engaged with one of the sprockets to another one of the sprockets. The one of the sprockets having the least teeth corresponds to, for example, the smallest transmission stage obtainable by the derailleur 22. The one of the sprockets having the most teeth corresponds to, for example, the largest transmission stage obtainable by the derailleur 22.

In a case where the derailleur 22 includes a front derailleur, the number of first sprockets is, for example, two or greater and three or less. In a case where the derailleur 22 includes a front derailleur, the number of first sprockets is, for example, two.

In a case where the derailleur 22 includes a rear derailleur, the number of second sprockets is, for example, two or greater and twenty or less. In a case where the derailleur 22 includes a rear derailleur, the number of second sprockets is, for example, twelve.

The motor 24 is configured to drive the transmission body 20. The motor 24 is, for example, configured to apply a propulsion force to the human-powered vehicle 10 in accordance with the human driving force. The motor 24 includes, for example, one or more electric motors. The electric motor of the motor 24 is, for example, a brushless motor. The motor 24 is, for example, configured to transmit a rotational force to a power transmission path of the human driving force extending from the pedals 32A and 32B to the second rotational body 18.

In the present embodiment, the motor 24 is, for example, configured to drive the transmission body 20 via the first rotational body 14. The motor 24 is, for example, provided on the frame 28 and configured to transmit a rotational force to the first rotational body 14. The motor 24 can have any configuration as long as the motor 24 is capable of driving the transmission body 20. The motor 24 can be configured to drive the transmission body 20 via the second rotational body 18. The motor 24 can be provided in a hub of the human-powered vehicle 10 and configured to transmit rotational force to the second rotational body 18.

The human-powered vehicle 10 further includes a housing 46 in which the motor 24 is provided. The motor 24 and the housing 46 form a drive unit 48. The housing 46 is attached to the frame 28. The crank axle 12 is rotatably supported by the housing 46. The motor 24 can be configured to transmit a rotational force to the transmission body 20 without using the first rotational body 14. In an example in which the motor 24 is configured to transmit rotational force to the transmission body 20 without using the first rotational body 14, a sprocket that engages the transmission body 20 is provided on an output shaft 24A of the motor 24 or a transmission member to which the force from the output shaft 24A of the motor 24 is transmitted.

The drive unit 48 further includes, for example, an output unit 50. The output unit 50 is, for example, arranged coaxially with the crank axle 12. The output unit 50 is, for example, configured to receive a human driving force and an output of the motor 24. The output unit 50 is, for example, configured to receive the rotational force of the crank axle 12 and the output of the motor 24. The output unit 50 is, for example, cylindrical. The output unit 50 is, for example, provided on an outer circumferential portion of the crank axle 12 about a rotational axis Cl of the crank axle 12. At least one first rotational body 14 is, for example, coupled to a first end 50A of the output unit 50 in a manner rotatable integrally with the output unit 50.

The drive unit 48 includes, for example, a speed reducer 52. The speed reducer 52 is, for example, provided between the motor 24 and the power transmission path of the human driving force. The speed reducer 52 includes, for example, at least one speed reducing unit. The at least one speed reducing unit includes, for example, a first speed reducing unit 52A, a second speed reducing unit 52B, and a third speed reducing unit 52C. The number of speed reducing units included in the speed reducer 52 can be one, two, four or more.

The first speed reducing unit 52A receives, for example, rotational torque of the motor 24. The first speed reducing unit 52A includes, for example, two gears meshed with each other. The first speed reducing unit 52A can include a belt and pulleys instead of the gears. The first speed reducing unit 52A can include sprockets and a chain instead of the gears.

The second speed reducing unit 52B receives, for example, the rotational torque of the motor 24 via the first speed reducing unit 52A. The second speed reducing unit 52B includes, for example, two gears meshed with each other. The second speed reducing unit 52B can include a belt and pulleys instead of the gears. The second speed reducing unit 52B can include sprockets and a chain instead of the gears.

The third speed reducing unit 52C receives, for example, the rotational torque of the motor 24 via the second speed reducing unit 52B. The third speed reducing unit 52C transmits the rotational torque of the motor 24 to, for example, the output unit 50. The third speed reducing unit 52C includes, for example, two gears meshed with each other. The third speed reducing unit 52C can include a belt and pulleys instead of the gears. The third speed reducing unit 52C can include sprockets and a chain instead of the gears.

The drive unit 48 further includes, for example, a second one-way clutch 54. The second one-way clutch 54 is provided in a power transmission path from the crank axle 12 to at least one first rotational body 14. The second one-way clutch 54 is, for example, provided between the crank axle 12 and the output unit 50.

The second one-way clutch 54 is, for example, configured to rotate the first rotational body 14 forward in a case where the crank axle 12 is rotated forward. The second one-way clutch 56 is, for example, further configured to allow relative rotation of the crank axle 12 and at least one first rotational body 14 in a case where the crank axle 12 is rotated rearward. The second one-way clutch 54 includes, for example, at least one of a roller clutch, a sprag clutch, and a ratchet clutch.

The drive unit 48 further includes, for example, a third one-way clutch 56. The third one-way clutch 56 is, for example, provided in a power transmission path extending from the motor 24 to at least one first rotational body 14. The third one-way clutch 56 is, for example, provided on the speed reducer 52.

The third one-way clutch 56 is, for example, configured to transmit the rotational force of the motor 24 to the output unit 50. The third one-way clutch 56 is, for example, configured to restrict transmission of the rotational force of the crank axle 12 to the motor 24 in a case where the crank axle 12 is rotated forward. The third one-way clutch 56 includes, for example, at least one of a roller clutch, a sprag clutch, and a ratchet clutch.

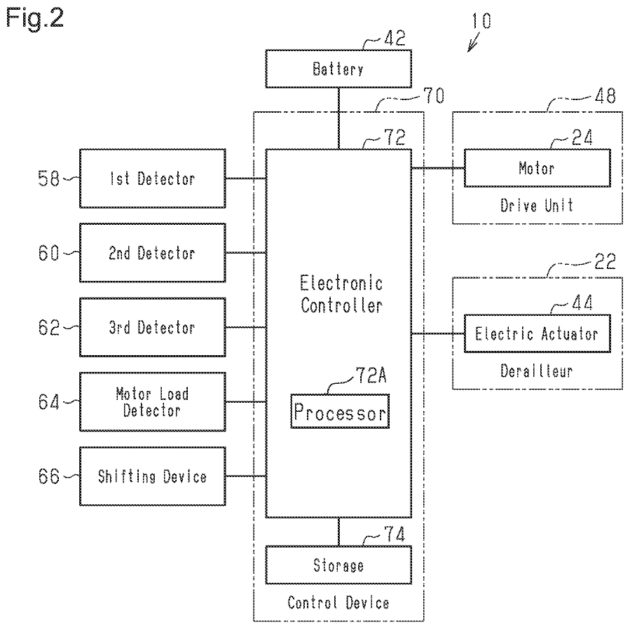

As seen in FIG. 2, the human-powered vehicle 10 further includes one or more detectors for detecting an operating condition of the human-powered vehicle 10. The term “detector” as used herein refers to a hardware device or instrument designed to detect the presence or absence of a particular event, object, substance, or a change in its environment, and to emit a signal in response. The term “detector” as used herein do not include a human being.

As seen in FIG. 2, the human-powered vehicle 10 further includes an electronic controller 72. The electronic controller 72 is configured to control the motor 24. The electronic controller 72 is configured to receive input signals from the detectors. In this way, the electronic controller 72 can control the motor 24 based on a human-powered vehicle condition (e.g., a traveling state of the human-powered vehicle or an operating state of a component of the human-powered vehicle) detected by one or more of the detectors.

The human-powered vehicle 10 further includes, for example, a first detector 58 and a second detector 60. The human-powered vehicle 10 further includes, for example, the first detector 58 and a third detector 62. The human-powered vehicle 10 can include every one of the first detector 58, the second detector 60, and the third detector 62.

In the present embodiment, the human-powered vehicle 10 includes the first detector 58, the second detector 60, and the third detector 62. The first detector 58 is, for example, connected to the electronic controller 72 in a manner allowing for wired communication or wireless communication. The second detector 60 is, for example, connected to the electronic controller 72 in a manner allowing for wired communication or wireless communication. The third detector 62 is, for example, connected to the electronic controller 72 in a manner allowing for wired communication or wireless communication.

The first detector 58 detects, for example, a parameter related to a rotational speed of the crank axle 12. The parameter related to a rotational speed of the crank axle 12 includes, for example, a rotational amount of at least one of the crank axle 12 and the first rotational body 14.

The parameter related to a rotational speed of the crank axle 12 includes, for example, a parameter corresponding to at least one of a rotational speed of the crank axle 12 and a rotational speed of the first rotational body 14. The parameter corresponding to a rotational speed of the crank axle 12 includes, for example, an angular acceleration of the crank axle 12. The parameter corresponding to a rotational speed of the first rotational body 14 includes, for example, an angular acceleration of the first rotational body 14.

The first detector 58 is, for example, configured to output a signal corresponding to at least one of the rotational speed of the crank axle 12 and the rotational speed of the first rotational body 14. The first detector 58 is, for example, configured to output a detection signal corresponding to a rotational angle of at least one of the crank axle 12 and the first rotational body 14 during a period in which at least one of the crank axle 12 and the first rotational body 14 completes one rotation.

The first detector 58 includes, for example, a magnetic sensor that outputs a signal corresponding to the strength of a magnetic field. The first detector 58 includes, for example, a ring-shaped magnet having magnetic poles arranged in a circumferential direction. The ring-shaped magnet is, for example, provided on the crank axle 12, the first rotational body 14, or the power transmission path between the crank axle 12 and the first rotational body 14. The ring-shaped magnet includes, for example, one S-pole and one N-pole. Each of the S-pole and the N-pole continuously extends over 180° about the rotational axis Cl of the crank axle 12. Instead of the magnetic sensor, the first detector 58 can include an optical sensor, an acceleration sensor, a gyro sensor, a torque sensor, or the like.

The first detector 58 is, for example, provided on the frame 28. In a case where the first detector 58 is provided on the frame 28, the first detector 58 can include a vehicle speed sensor. In a case where the first detector 58 includes a vehicle speed sensor, the electronic controller 72 can be configured to calculate the rotational speed of the crank axle 12 in accordance with the speed detected by the vehicle speed sensor and the transmission ratio. The first detector 58 can be provided on the drive unit 48.

The first detector 58 can be configured to detect a rotational amount of the second rotational body 18. The first detector 58 can be configured to detect information corresponding to rotational speed of the second rotational body 18. The information corresponding to the rotational speed of the second rotational body 18 includes, for example, angular acceleration of the second rotational body 18. The first detector 58 can be configured to output a signal corresponding to the rotational speed of the second rotational body 18.

The second detector 60 detects a parameter related to a rotational speed of the wheel 16. The parameter related to a rotational speed of the wheel 16 includes, for example, a parameter related to speed of the human-powered vehicle 10. The second detector 60 is, for example, configured to detect a magnet provided on at least one of the front wheel 16F and the rear wheel 16R.

The second detector 60 is, for example, configured to output a predetermined number of detection signals during a period in which the wheel 16 completes one rotation. The predetermined number is, for example, one. The second detector 60 outputs, for example, a signal corresponding to the rotational speed of the wheel 16. The electronic controller 72 can calculate the speed of the human-powered vehicle 10 based on the signal corresponding to the rotational speed of the wheel 16 and information related to the circumferential length of the wheel 16. The information related to the circumferential length of the wheel 16 is, for example, stored in storage 74.

The third detector 62 detects a parameter related to a human torque that is input to the crank axle 12 of the human-powered vehicle 10. The parameter related to the human torque input to the crank axle 12 includes, for example, a parameter related to the human driving force that is input to the crank axle 12. The third detector 62 is, for example, configured to output a signal corresponding to the human torque that is input to the crank axle 12. The signal corresponding to the human torque input to the crank axle 12 includes a signal related to the human driving force that is input to the crank axle 12.

The third detector 62 is, for example, provided on a member included in the transmission path of the human driving force or a member arranged near the member included in the transmission path of the human driving force. The member included in the transmission path of the human driving force includes, for example, the crank axle 12 and a member that transmits the human driving force between the crank axle 12 and the first rotational body 14. The third detector 62 is, for example, provided on a power transmission portion configured to transmit the human driving force from the crank axle 12 to the output unit 50. The power transmission portion is, for example, provided on the outer circumferential portion of the crank axle 12.

The third detector 62 includes a strain sensor, a magnetostrictive sensor, a pressure sensor, or the like. A strain sensor includes a strain gauge. The third detector 62 can have any configuration as long as the parameter related to a human torque that is input to the crank axle 12 is obtained.

The third detector 62 can be provided on at least one of the crank arms 30A and 30B or at least one of the pedals 32A and 32B. In a case where the third detector 62 is provided on at least one of the pedals 32A and 32B, the third detector 62 can include a sensor that detects the pressure applied to the at least one of the pedals 32A and 32B. The third detector 62 can be provided on the chain included in the transmission body 20. In a case where the third detector 62 is provided on the chain, the third detector 62 can include a sensor that detects the tension on the chain.

The human-powered vehicle 10 can further include a motor load detector 64 configured to detect a load on the motor 24. The motor load detector 64 is, for example, connected to the electronic controller 72 in a manner allowing for wired communication or wireless communication. The motor load detector 64 is, for example, configured to detect the load on the motor 24. The motor load detector 64 includes, for example, a current sensor that detects the current flowing through the motor 24 and a rotation sensor that detects a rotational speed of the motor 24. The load on the motor 24 can be detected using a known technique based on the current flowing through the motor 24 and the rotational speed of the motor 24. Thus, the load on the motor 24 will not be described in detail. The motor load detector 64 can be included in the motor 24.

As mentioned above, the human-powered vehicle control device 70 includes the electronic controller 72. The electronic controller 72 includes, for example, one or more processors 72A that execute predetermined control programs. Each of the processors 72A of the electronic controller 72 includes, for example, a central processing unit (CPU) or a micro-processing unit (MPU).

The processors 72A of the electronic controller 72 can be located at separate positions. Some of the processors 72A can be located on the human-powered vehicle 10, and the other processors 72A can be located in a server connected to the internet. In a case where the processors 72A are located at separate positions, the processors 72A are connected to one another via a wireless communication device in a manner allowing for communication. The electronic controller 72 can include one or more microcomputers. The electronic controller 72 is formed of one or more semiconductor chips that are mounted on a circuit board. Thus, the terms “electronic controller” and “controller” as used herein refers to hardware that executes a software program, and does not include a human being.

The control device 70 further includes, for example, the storage 74. The storage 74 is any computer storage device or any non-transitory computer-readable medium with the sole exception of a transitory, propagating signal. The storage 74 is, for example, connected to the electronic controller 72 in a manner allowing for wired communication or wireless communication. The storage 74 stores, for example, control programs and information used for control processes. The storage 74 includes, for example, a non-volatile memory and a volatile memory. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM).

The control device 70 can further include a drive circuit of the motor 24. The electronic controller 72 and the drive circuit are, for example, provided in the housing 46. The electronic controller 72 and the drive circuit can be provided on the same circuit board. The drive circuit is, for example, connected to the electronic controller 72 in a manner allowing for wired communication or wireless communication. The drive circuit drives the motor 24 in response to, for example, a control signal from the electronic controller 72.

The drive circuit is, for example, electrically connected to the motor 24. The drive circuit controls, for example, supply of electric power from the battery 42 to the motor 24. The drive circuit includes, for example, an inverter circuit. The inverter circuit includes, for example, transistors. The inverter circuit is, for example, configured such that inverter units are connected to one another in parallel and each inverter unit is formed by two transistors connected in series. The inverter circuit can include a current sensor that detects the current flowing through the inverter circuit. The current sensor is, for example, connected to the electronic controller 72 in a manner allowing for wired communication or wireless communication.

The electronic controller 72 is, for example, configured to control the motor 24. The electronic controller 72 is, for example, configured to control the motor 24 in accordance with a state of the human-powered vehicle 10. The electronic controller 72 is, for example, configured to control the motor 24 so that the output of the motor 24 changes in accordance with the human driving force input to the human-powered vehicle 10. The electronic controller 72 is, for example, configured to control the motor 24 so that the propulsion force changes in accordance with the human driving force input to the human-powered vehicle 10. The electronic controller 72 is, for example, configured to control the motor 24 in accordance with the human driving force detected by the third detector 62.

The electronic controller 72 is, for example, configured to control the motor 24 in accordance with at least one of the rotational speed of the crank axle 12 and the rotational speed of the first rotational body 14 detected by the first detector 58. The electronic controller 72 is, for example, configured to control the motor 24 in accordance with the speed of the human-powered vehicle 10 detected by the second detector 60.

The electronic controller 72 can be configured to drive the motor 24 so as to apply a propulsion force to the human-powered vehicle 10 in accordance with at least one of the human driving force and the rotational speed of the crank axle 12 in a case where the speed of the human-powered vehicle 10 is less than or equal to a first vehicle speed. The predetermined first vehicle speed is, for example, set by regulations. The first vehicle speed is, for example, 25 km/h or 27.5 km/h.

The electronic controller 72 is, for example, configured to control the motor 24 so that an assist level of the motor 24 is a predetermined assist level. The assist level includes, for example, at least one of a ratio of the output of the motor 24 to the human driving force input to the human-powered vehicle 10, the maximum value of the output of the motor 24, and a restriction level that restricts changes in the output of the motor 24 in a case where the output of the motor 24 decreases.

The electronic controller 72 is, for example, configured to control the motor 24 so that a ratio of the assist force to the human driving force is a predetermined ratio. The human driving force corresponds to, for example, the propulsion force of the human-powered vehicle 10 produced by the user rotating the crank axle 12. The human driving force corresponds to, for example, the driving force input to the first rotational body 14 by the user rotating the crank axle 12.

The assist force includes, for example, the driving force input to the first rotational body 14 in accordance with the output of the motor 24. The assist force corresponds to, for example, the propulsion force of the human-powered vehicle 10 produced by rotation of the motor 24. In an example in which the drive unit 48 includes the speed reducer 52, the assist force corresponds to the output of the speed reducer 52.

The predetermined ratio does not have to be set constant and can be varied in accordance with at least one of the human driving force, the rotational speed of the crank axle 12, the rotational speed of the first rotational body 14, and the vehicle speed. The predetermined ratio does not have to be set constant and can be varied in accordance with the vehicle speed and at least one of the human driving force, the rotational speed of the crank axle 12, and the rotational speed of the first rotational body 14.

The human driving force corresponds to, for example, the propulsion force of the human-powered vehicle 10 produced by the user rotating the crank axle 12. The human driving force corresponds to, for example, the driving force input to the first rotational body 14 by the user rotating the crank axle 12. The human driving force is, for example, expressed as at least one of torque and power. In a case where the human driving force is expressed as torque, the human driving force is described as, for example, human torque. The power of the human driving force is, for example, the product of the torque applied to the crank axle 12 and the rotational speed of the crank axle 12.

The assist force is, for example, expressed as at least one of torque and power. In a case where the assist force is expressed as a torque, the assist force is described as, for example, an assist torque. In a case where the assist force is expressed as a power, the assist force is described as, for example, an assist power. The assist power is, for example, the product of the output torque of the speed reducer 52 and the rotational speed of an output shaft of the speed reducer 52. The ratio of the assist force to the human driving force can be a ratio of the assist torque to the human torque or a ratio of the assist power to the power of the human force.

The electronic controller 72 is, for example, configured to control the motor 24 so that the assist force is less than or equal to the maximum assist force. The electronic controller 72 is, for example, configured to control the motor 24 so that the assist torque is less than or equal to the maximum assist torque. The maximum assist torque is, for example, a value in a range from 20 Nm or greater and 200 Nm or less. The maximum assist torque is, for example, determined by at least one of an output characteristic and a control mode of the motor 24. The electronic controller 72 can be configured to control the motor 24 so that the assist power is less than or equal to the maximum assist power.

The electronic controller 72 is configured to control the motor 24 so as to drive the transmission body 20 with the motor 24 without propelling the human-powered vehicle 10 with the driving force of the motor 24 in a case where a first condition in which the crank axle 12 is rotated and the human-powered vehicle 10 is propelled without a human driving force and a shifting condition for shifting the transmission ratio with the derailleur 22 are satisfied.

The electronic controller 72 is, for example, configured to control the motor 24 so as to drive the transmission body 20 with the motor 24 without propelling the human-powered vehicle 10 with the driving force of the motor 24 in a case where the first condition and the shifting condition are satisfied. The electronic controller 72 can be configured to control the motor 24 so as to drive the transmission body 20 with the motor 24 without rotating the wheel 16 with the driving force of the motor 24 in a case where the first condition and the shifting condition are satisfied.

A case where the crank axle 12 is rotated and the human-powered vehicle 10 is propelled without a human driving force includes, for example, a case where a rider traveling on a downhill rotates the crank axle 12 and the rotation of the crank axle 12 is not transmitted to the wheel 16. In an example in which the crank axle 12 is rotated and the human-powered vehicle 10 is propelled without human driving force, the rotational speed of the crank axle 12 is less than or equal to an estimated rotational speed calculated from the vehicle speed and the transmission ratio. In a case where the rotational speed of the crank axle 12 is less than or equal to the estimated rotational speed calculated from the vehicle speed and the transmission ratio, at least one of the first one-way clutch and the second one-way clutch 54 does not transmit the rotation of the crank axle 12 to the wheel 16.

In an example in which the crank axle 12 is rotated and the transmission body 20 is driven by the motor 24, the motor 24 transmits rotational torque to the output unit 50 so that the output unit 50 rotates the first rotational body 14. In this manner, the motor 24 drives the transmission body 20 in a case where the crank axle 12 is rotated and the human-powered vehicle 10 is propelled without a human driving force.

The first condition includes, for example, a condition in which the rotational speed of the crank axle 12 obtained from the detection of the first detector 58 is greater than zero and a condition in which the rotational speed of the crank axle 12 is less than or equal to an estimated rotational speed calculated from the transmission ratio and the rotational speed of the wheel 16 obtained from the detection of the second detector 60.

The estimated rotational speed is, for example, calculated from the transmission ratio of the human-powered vehicle 10 and the speed of the human-powered vehicle 10. The estimated rotational speed can be, for example, calculated by dividing the rotational speed of the wheel 16 by the transmission ratio. The estimated rotational speed is, for example, calculated by equation (2). In equation (2), the term “CX” represents the estimated rotational speed. In equation (2), the term “V” represents the vehicle speed. In equation (2), the term “R” represents the transmission ratio. In expression (2), the term “L” represents the circumferential length of the wheel 16.

CX(rpm)=[V(km/h)×1000]/[R×60×L(m)] Equation (2):

The electronic controller 72 is, for example, configured to obtain the transmission ratio based on a control instruction to the derailleur 22. The electronic controller 72 can be configured to obtain the transmission ratio based on an operation signal from a shifting device 66. In a case where the human-powered vehicle 10 is propelled by human driving force, the electronic controller 72 can be configured to obtain the transmission ratio based on the vehicle speed, the rotational speed of the crank axle 12, and the circumferential length of a tire. The electronic controller 72 determines that the first condition is satisfied in an example in which the rotational speed of the crank axle 12 is greater than zero and the rotational speed of the crank axle 12 is less than or equal to the estimated rotational speed.

The first condition is, for example, satisfied in a case where the rotational speed of the crank axle 12 obtained from a detection value of the first detector 58 is greater than zero and the human torque obtained from a detection value of the third detector 62 is less than or equal to a predetermined torque. The predetermined torque is, for example, 0 Nm or greater and 5 Nm or less. The predetermined torque is, for example, set to a value that allows for determination of a state in which the human-powered vehicle 10 is propelled without a human driving force.

The first condition does not have to include one of the condition in which the rotational speed of the crank axle 12 is greater than zero and the rotational speed of the crank axle 12 is less than or equal to the estimated rotational speed, and the condition in which the rotational speed of the crank axle 12 is greater than zero and the human torque is less than or equal to the predetermined torque. In a case where the first condition does not include the condition in which the rotational speed of the crank axle 12 is greater than zero and the rotational speed of the crank axle 12 is less than or equal to the estimated rotational speed, the second detector 60 can be omitted. In a case where the first condition does not include the condition in which the rotational speed of the crank axle 12 is greater than zero and the human torque is less than or equal to the predetermined torque, the third detector 62 can be omitted.

The shifting condition is, for example, related to at least one of a traveling state of the human-powered vehicle 10, a traveling environment of the human-powered vehicle 10, and an operating state of the shifting device 66 of the human-powered vehicle 10. The traveling environment of the human-powered vehicle 10 includes, for example, at least one of gradient and traveling resistance of a road surface. The traveling state of the human-powered vehicle 10 includes, for example, a vehicle speed, a rotational speed of the crank axle 12, a human driving force, and an inclination angle of the human-powered vehicle 10. The shifting device 66 is, for example, configured to be operable by the user.

The shifting condition is, for example, satisfied in a case where the electronic controller 72 receives a shifting instruction from the shifting device 66. The shifting condition can be a condition related to automatic shifting and satisfied, for example, in at least one of a case where the traveling state of the human-powered vehicle 10 satisfies a predetermined state and a case where the traveling environment of the human-powered vehicle 10 satisfies a predetermined state. The shifting instruction includes, for example, a shifting instruction for increasing the transmission ratio and a shifting instruction for decreasing the transmission ratio.

The electronic controller 72 is, for example, configured to control the derailleur 22. For example, the electronic controller 72 drives the transmission body 20 with the motor 24 and operates the transmission body 20 with the derailleur 22 in a case where the first condition and the shifting condition are satisfied. For example, the electronic controller 72 drives the transmission body 20 with the driving force of the motor 24 that is insufficient for propelling the human-powered vehicle 10 and operates the transmission body 20 with the derailleur 22 in a case where the first condition and the shifting condition are satisfied.

The electronic controller 72 is, for example, configured to drive the transmission body 20 with the motor 24 and operate the transmission body 20 with the derailleur 22 as the rider rides the traveling human-powered vehicle 10 in a case where the shifting condition is satisfied and the crank axle 12 is rotated at a rotational speed that is less than or equal to the estimated rotational speed. The electronic controller 72 is, for example, configured to drive the transmission body 20 with the motor 24 and operate the transmission body 20 with the derailleur 22 as the rider rides the traveling human-powered vehicle 10 in a case where the shifting condition is satisfied and the crank axle 12 is rotated in a state in which the human torque is less than or equal to the predetermined torque.

The electronic controller 72 is, for example, configured to drive the transmission body 20 with the motor 24 without propelling the human-powered vehicle 10 with the driving force of the motor 24 and operate the transmission body 20 with the derailleur 22 in a case where a second condition and the shifting condition are satisfied.

The second condition is satisfied in a case where rotation of the crank axle 12 is stopped. The electronic controller 72 is, for example, configured to determine that rotation of the crank axle 12 is stopped in a case where the rotational speed of the crank axle 12 is less than or equal to a predetermined rotational speed. The electronic controller 72 is, for example, configured to determine that the first condition is satisfied in an example in which the rotational speed of the crank axle 12 is less than or equal to the predetermined rotational speed. The predetermined rotational speed is, for example, 0 rpm or greater and 5 rpm or less. The predetermined rotational speed is, for example, 3 rpm. The predetermined rotational speed can be greater than 0 rpm.

The predetermined rotational speed can be set based on the rotational speed at which the crank axle 12 rotates back and forth in a case where the rider stops pedaling. The electronic controller 72 can be configured to determine that rotation of the crank axle 12 is stopped in a case where the human driving force is less than or equal to a crank axle stopping determination driving force. The crank axle stopping determination driving force corresponds to, for example, human torque that is 1 Nm or greater and 5 Nm or less.

In a case where the first condition and the shifting condition are satisfied and the motor 24 is driven, the electronic controller 72 is, for example, configured to stop the motor 24 upon a stopping condition of the motor 24 being satisfied. The stopping condition includes, for example, at least one of a first stopping condition in which a predetermined period elapses from when driving of the motor 24 is started and a second stopping condition in which a load on the motor 24 is greater than or equal to a first threshold value. The electronic controller 72 determines that the stopping condition of the motor 24 is satisfied in an example in which at least one of the first stopping condition, in which the predetermined period elapses from when driving of the motor 24 is started, and the second stopping condition, in which the load on the motor 24 is greater than or equal to the first threshold value, is satisfied.

The first threshold value is, for example, a value allowing for determination that a foreign object or the like has been caught in at least one of the transmission body 20, the first rotational body 14, and the second rotational body 18. The first threshold value can be a value allowing for determination that the transmission body 20 is tensioned. The predetermined period includes at least one of a predetermined time, a period during which the output shaft 24A of the motor 24 is rotated more than a first rotational angle, and a period during which the first rotational body 14 is rotated by the motor 24 more than a second rotational angle. The predetermined period is, for example, set to a period necessary for checking actuation of at least one of the motor 24, the transmission body 20, the first rotational body 14, and the second rotational body 18. The period necessary for checking actuation of at least one of the motor 24, the transmission body 20, the first rotational body 14, and the second rotational body 18 is, for example, set based on the resolution of a sensor that detects actuation of at least one of the motor 24, the transmission body 20, the first rotational body 14, and the second rotational body 18. The predetermined time is, for example, one second or longer and ten seconds or shorter. The first rotational angle is, for example, 180 degrees or greater and 720 degrees or less. The second rotational angle is, for example, 90 degrees or greater and 360 degrees or less. The predetermined period can be set by the user.

In a case where the second condition and the shifting condition are satisfied and the motor 24 is driven, the electronic controller 72 can be configured to stop the motor 24 upon the stopping condition of the motor 24 being satisfied. The electronic controller 72 can be configured to stop the motor 24 in a case where the user operates an operating unit differing from the shifting device 66 and configured to stop the motor 24.

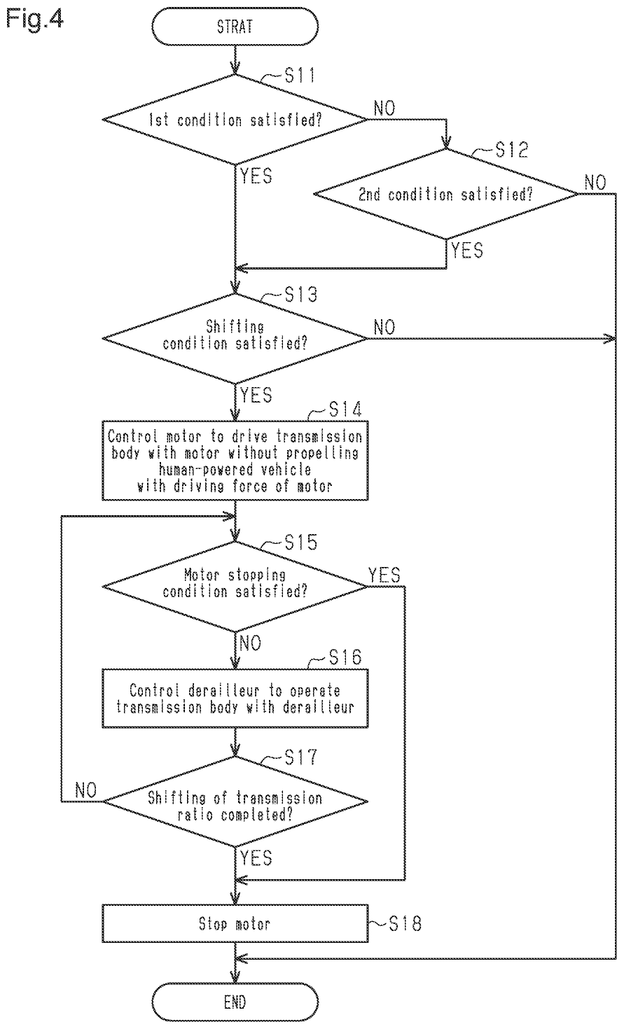

A process executed by the electronic controller 72 to control the motor 24 will now be described with reference to FIG. 4. In an example in which electric power is supplied to the electronic controller 72, the electronic controller 72 starts the process of the flowchart shown in FIG. 4 from step S11. In a case where the process of the flowchart shown in FIG. 4 ends, the electronic controller 72 repeats the process from step S11 in predetermined cycles until, for example, the supply of electric power stops.

In step S11, the electronic controller 72 determines whether the first condition is satisfied. In a case where the first condition is not satisfied, the electronic controller 72 proceeds to step S12. In a case where the first condition is satisfied, the electronic controller 72 proceeds to step S13. In step S12, the electronic controller 72 determines whether the second condition is satisfied. In a case where the second condition is satisfied, the electronic controller 72 proceeds to step S13. In a case where the second condition is not satisfied, the electronic controller 72 ends processing.

In step S13, the electronic controller 72 determines whether the shifting condition is satisfied. In a case where the shifting condition is satisfied, the electronic controller 72 proceeds to step S14. In a case where the shifting condition is not satisfied, the electronic controller 72 ends processing. In step 44, the electronic controller 72 controls the motor 24 so as to drive the transmission body 20 with the motor 24 without propelling the human-powered vehicle 10 with the driving force of the motor 24. Then, the electronic controller 72 proceeds to step S15.

In step S15, the electronic controller 72 determines whether the stopping condition of the motor 24 is satisfied. In a case where the stopping condition of the motor 24 is not satisfied, the electronic controller 72 proceeds to step S16. In step S16, the electronic controller 72 controls the derailleur 22 so as to operate the transmission body 20 with the derailleur 22 and then proceeds to step S17.

In step S17, the electronic controller 72 determines whether shifting of the transmission ratio is completed. In a case where shifting of the transmission ratio has been completed, the electronic controller 72 proceeds to step S18. In a case where shifting of the transmission ratio is not completed, the electronic controller 72 proceeds to step S15 and repeats the process from step S15. In a case where the stopping condition of the motor 24 is satisfied in step S15, the electronic controller 72 proceeds to step S18. In step S18, the electronic controller 72 stops the motor 24 and then ends processing.

Step S12 can be omitted from the process shown in FIG. 4. In a case where step S12 is omitted and a negative determination is given in step S11, the electronic controller 72 ends processing. The order of steps S12 and S11 can be switched.

Steps S15 and S18 can be omitted from the process shown in FIG. 4. In a case where steps S15 and S18 are omitted, the electronic controller 72 proceeds to step S16 after step S14. In a case where steps S15 and S18 are omitted and an affirmative determination is given in step S17, the electronic controller 72 ends processing. In a case where steps S15 and S18 are omitted and a negative determination is given in step S17, the electronic controller 72 returns to step S17 and executes step S17 again.

Steps S16 and S17 can be omitted from the process shown in FIG. 4. In a case where steps S16 and S17 are omitted and a negative determination is given in step S15, the electronic controller 72 repeats step S15. In a case where steps S16 and S17 are omitted, the derailleur 22 does not have to include the electric actuator 44. In a case where steps S16 and S17 are omitted, the derailleur 22 can be, for example, a manually-operated derailleur.

Every one of steps S15 to S18 can be omitted. In a case where steps S15 to S18 are omitted, the electronic controller 72 ends processing after step S14.

### Second Embodiment

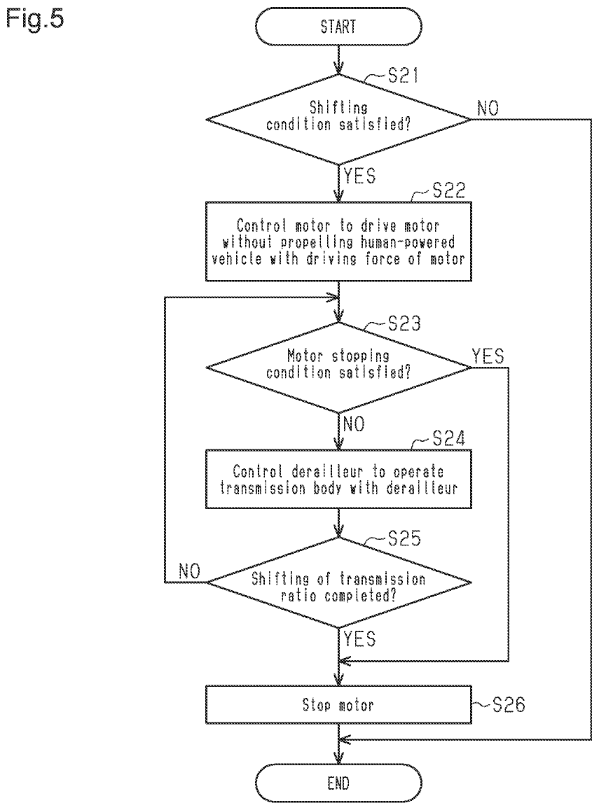

A human-powered vehicle control device 70 in accordance with a second embodiment will now be described with reference to FIG. 5. Same reference numerals are given to those components of the human-powered vehicle control device 70 in the second embodiment that are the same as the corresponding components in the first embodiment. Such components will not be described in detail.

In the second embodiment, the electronic controller 72 is configured to control the motor 24 and the derailleur 22. In a case where the shifting condition for shifting the transmission ratio with the derailleur 22 is satisfied, the electronic controller 72 is configured to drive the transmission body 20 with the motor 24 without propelling the human-powered vehicle 10 with the driving force of the motor 24 and operate the transmission body 20 with the derailleur 22 regardless of the rotational speed of the crank axle 12.

In an example in which the shifting condition is satisfied and the motor 24 is driven, the electronic controller 72 is configured to stop driving the motor 24 upon the stopping condition of the motor 24 being satisfied. The stopping condition of the motor 24 is the same as the stopping condition of the motor 24 in the first embodiment.

A process executed by the electronic controller 72 of the second embodiment to control the motor 24 will now be described with reference to FIG. 5. In an example in which electric power is supplied to the electronic controller 72, the electronic controller 72 starts the process of the flowchart shown in FIG. 5 from step S21. In a case where the process of the flowchart shown in FIG. 5 ends, the electronic controller 72 repeats the process from step S21 in predetermined cycles until, for example, the supply of electric power stops.

In step S21, the electronic controller 72 determines whether the shifting condition is satisfied. In a case where the shifting condition is not satisfied, the electronic controller 72 ends processing. In a case where the shifting condition is satisfied, the electronic controller 72 proceeds to step S22. In step S22, the electronic controller 72 controls the motor 24 to drive the motor 24 without propelling the human-powered vehicle 10 with the driving force of the motor 24. Then, the electronic controller 72 proceeds to step S23.

In step S23, the electronic controller 72 determines whether the stopping condition of the motor 24 is satisfied. In a case where the stopping condition of the motor 24 is not satisfied, the electronic controller 72 proceeds to step S24. In step S24, the electronic controller 72 controls the derailleur 22 so as to operate the transmission body 20 with the derailleur 22. Then, the electronic controller 72 proceeds to step S25.

In step S25, the electronic controller 72 determines whether shifting of the transmission ratio is completed. In a case where shifting of the transmission ratio has been completed, the electronic controller 72 proceeds to step S26. In a case where shifting of the transmission ratio is not completed, the electronic controller 72 proceeds to step S23 and repeats the process from step S23. In a case where the stopping condition of the motor 24 is satisfied in step S23, the electronic controller 72 proceeds to step S26. In step S26, the electronic controller 72 stops the motor 24 and then ends processing.

Steps S23 and S26 can be omitted from the process shown in FIG. 5. In a case where steps S23 and S26 are omitted, the electronic controller 72 proceeds to step S24 after step S22. In a case where steps S23 and S26 are omitted and an affirmative determination is given in step S25, the electronic controller 72 ends processing. In a case where steps S23 and S26 are omitted and a negative determination is given in step S25, the electronic controller 72 repeats step S25. Step S25 can be omitted from the process shown in FIG. 5. In a case where step S25 is omitted, the electronic controller 72 proceeds to step S26 after step S24.

### Third Embodiment

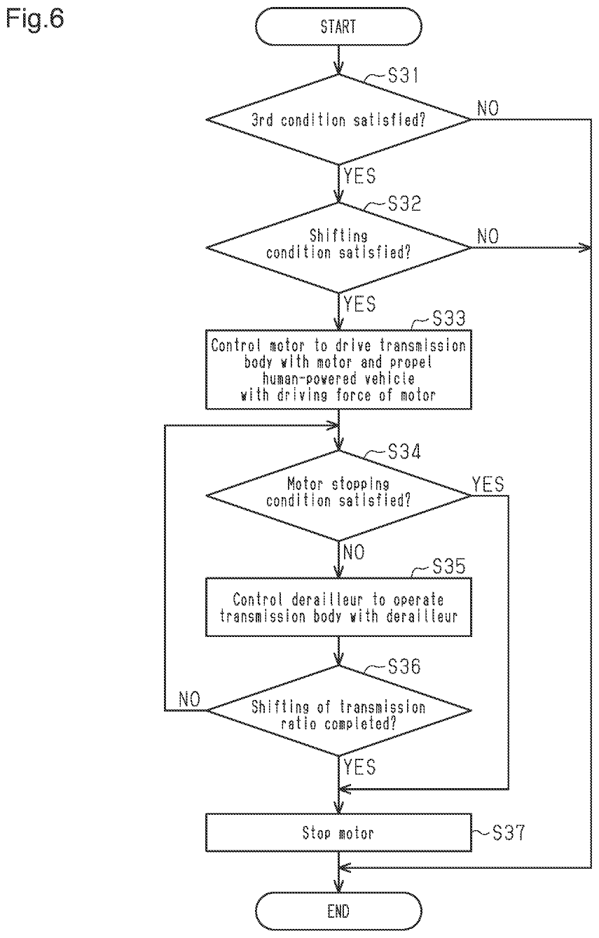

A human-powered vehicle control device 70 in accordance with a third embodiment will now be described with reference to FIG. 6. Same reference numerals are given to those components of the human-powered vehicle control device 70 in the third embodiment that are the same as the corresponding components in the first and second embodiments. Such components will not be described in detail.

In the third embodiment, the electronic controller 72 controls the motor 24 so as to drive the transmission body 20 with the motor 24 and propel the human-powered vehicle 10 with the driving force of the motor 24 in a case where a third condition and a shifting condition for shifting the transmission ratio with the derailleur 22 are satisfied. The electronic controller 72 is, for example, configured to drive the transmission body 20 with the motor 24 to propel the human-powered vehicle 10 with the driving force of the motor 24 and operate the transmission body 20 with the derailleur 22 to shift the transmission ratio in a case where third condition and the shifting condition are satisfied.

The third condition includes, for example, a condition related to speed of the human-powered vehicle 10. The third condition is, for example, satisfied in a case where the speed of the human-powered vehicle 10 is increased. The third condition can be satisfied in a case where the rotational speed of the crank axle 12 is increased. The third condition can be satisfied in a case where the rotational speed of the wheel 16 is increased. The electronic controller 72 determines that the third condition is satisfied in an example in which the speed of the human-powered vehicle 10 is increased. The electronic controller 72 can determine that the third condition is satisfied in a case where the rotational speed of the crank axle 12 is greater than the estimated rotational speed.

In a case where the third condition and the shifting condition are satisfied, the shifting condition is satisfied, for example, if the electronic controller 72 generates a shifting instruction for increasing the transmission ratio with the derailleur 22. In a case where the third condition is satisfied, the shifting condition can be satisfied if the user operates the shifting device 66 to generate a shifting instruction for increasing the transmission ratio with the derailleur 22. The electronic controller 72 can be configured to control the motor 24 so as to drive the transmission body 20 with the motor 24 and propel the human-powered vehicle 10 with the driving force of the motor 24 in a case where the speed of the human-powered vehicle 10 is increased and a shifting instruction for increasing the transmission ratio with the derailleur 22 is issued.

In a case where the third condition and the shifting condition are satisfied and the motor 24 is thereby driven to apply a propulsion force to the human-powered vehicle 10, the electronic controller 72 is, for example, configured to control the motor 24 so as stop driving the motor 24 upon the stopping condition being satisfied. The stopping condition of the motor 24 is the same as the stopping condition of the motor 24 in the first embodiment.

A process executed by the electronic controller 72 of the third embodiment to control the motor 24 will now be described with reference to FIG. 6. In an example in which electric power is supplied to the electronic controller 72, the electronic controller 72 starts the process of the flowchart shown in FIG. 6 from step S31. In a case where the process of the flowchart shown in FIG. 6 ends, the electronic controller 72 repeats the process from step S31 in predetermined cycles until, for example, the supply of electric power stops.

In step S31, the electronic controller 72 determines whether the third condition is satisfied. In a case where the third condition is not satisfied, the electronic controller 72 ends processing. In a case where the third condition has been satisfied, the electronic controller 72 proceeds to step S32. In step S32, the electronic controller 72 determines whether the shifting condition is satisfied. In a case where the shifting condition is not satisfied, the electronic controller 72 ends processing. In a case where the shifting condition is satisfied, the electronic controller 72 proceeds to step S33.

In step 33, the electronic controller 72 controls the motor 24 so as to drive the transmission body 20 with the motor 24 and propel the human-powered vehicle 10 with the driving force of the motor 24. Then, the electronic controller 72 proceeds to step S34.

In step S34, the electronic controller 72 determines whether the stopping condition of the motor 24 is satisfied. In a case where the stopping condition of the motor 24 is not satisfied, the electronic controller 72 proceeds to step S35. In step S35, the electronic controller 72 controls the derailleur 22 so as to operate the transmission body 20 with the derailleur 22. Then, the electronic controller 72 proceeds to step S36.

In step S36, the electronic controller 72 determines whether shifting of the transmission ratio is completed. In a case where shifting of the transmission ratio has been completed, the electronic controller 72 proceeds to step S37. In a case where shifting of the transmission ratio is not completed, the electronic controller 72 proceeds to step S34 and repeats the process from step S34. In a case where the stopping condition of the motor 24 has been satisfied in step S34, the electronic controller 72 proceeds to step S37. In step S37, the electronic controller 72 stops the motor 24 and then ends processing.

Steps S34 and S37 can be omitted from the process shown in FIG. 6. In a case where steps S34 and S37 are omitted, the electronic controller 72 proceeds to step S35 after step S33. In a case where steps S34 and S37 are omitted and an affirmative determination is given in step S36, the electronic controller 72 ends processing. In a case where steps S34 and S37 are omitted and a negative determination is given in step S36, the electronic controller 72 returns to step S36 and executes step S36 again.

Steps S35 and S36 can be omitted from the process shown in FIG. 6. In a case where steps S35 and S36 are omitted and a negative determination is given in step S34, the electronic controller 72 repeats step S34. Steps S34 to S37 can be omitted from the process shown in FIG. 6. In a case where steps S34 to S37 are omitted, the electronic controller 72 ends processing after step S33.

### Modifications

The description related to the above embodiments exemplifies, without any intention to limit, applicable forms of a control device for a human-powered vehicle according to the present disclosure. In addition to the embodiments described above, the human-powered vehicle control device according to the present disclosure is applicable to, for example, modifications of the above embodiments that are described below and combinations of at least two of the modifications that do not contradict each other. In the modifications described hereafter, same reference numerals are given to those components that are the same as the corresponding components of the above embodiments. Such components will not be described in detail.

The electronic controller 72 can be configured not to control the derailleur 22. In a case where the electronic controller 72 is configured not to control the derailleur 22, the derailleur 22 can be a manually-operated derailleur that does not include the electric actuator 44. The manually-operated derailleur is, for example, connected to the shifting device 66 by a Bowden cable.

As long as the human-powered vehicle control device 70 in accordance with the first embodiment is configured as described below, any other configuration can be omitted. The human-powered vehicle control device 70 includes the electronic controller 72. The human-powered vehicle 10 includes the crank axle 12, the crank axle 12 configured to receive human driving force, the first rotational body 14 connected to the crank axle 12, the wheel 16, the second rotational body 18 connected to the wheel 16, the transmission body 20 engaged with the first rotational body 14 and the second rotational body 18 and configured to transmit driving force between the first rotational body 14 and the second rotational body 18, the derailleur 22 configured to operate the transmission body 20 to shift the transmission ratio of the rotational speed of the wheel 16 to the rotational speed of the crank axle 12, and the motor 24 configured to drive the transmission body 20. The electronic controller 72 is configured to control the motor 24 so as to drive the transmission body 20 with the motor 24 without propelling the human-powered vehicle 10 with the driving force of the motor 24 in a case where the first condition in which the crank axle 12 is rotated and the human-powered vehicle 10 is propelled without human driving force and the shifting condition for shifting the transmission ratio with the derailleur 22 are satisfied.

As long as the human-powered vehicle control device 70 in accordance with the second embodiment is configured as described below, any other configuration can be omitted. The human-powered vehicle control device 70 includes the electronic controller 72. The human-powered vehicle 10 includes the crank axle 12, the crank axle 12 configured to receive human driving force, the first rotational body 14 connected to the crank axle 12, the wheel 16, the second rotational body 18 connected to the wheel 16, the transmission body 20 engaged with the first rotational body 14 and the second rotational body 18 and configured to transmit driving force between the first rotational body 14 and the second rotational body 18, the derailleur 22 configured to operate the transmission body 20 to shift the transmission ratio of the rotational speed of the wheel 16 to the rotational speed of the crank axle 12, and the motor 24 configured to drive the transmission body 20. The electronic controller 72 is configured to control the motor 24 and the derailleur 22. In a case where the shifting condition for shifting the transmission ratio with the derailleur 22 is satisfied, the electronic controller 72 is configured to drive the transmission body 20 with the motor 24 without propelling the human-powered vehicle 10 with the driving force of the motor 24 and operate the transmission body 20 with the derailleur 22 to shift the transmission ratio regardless of the rotational speed of the crank axle 12.

As long as the human-powered vehicle control device 70 in accordance with the third embodiment is configured as described below, any other configuration can be omitted. The human-powered vehicle control device 70 includes the electronic controller 72. The human-powered vehicle 10 includes the crank axle 12, the crank axle 12 configured to receive human driving force, the first rotational body 14 connected to the crank axle 12, the wheel 16, the second rotational body 18 connected to the wheel 16, the transmission body 20 engaged with the first rotational body 14 and the second rotational body 18 and configured to transmit driving force between the first rotational body 14 and the second rotational body 18, the derailleur 22 configured to operate the transmission body 20 to shift the transmission ratio of the rotational speed of the wheel 16 to the rotational speed of the crank axle 12, and the motor 24 configured to drive the transmission body 20. The electronic controller 72 is configured to control the motor 24 so as to drive the transmission body 20 with the motor 24 and propel the human-powered vehicle 10 with the driving force of the motor 24 in a case where the third condition and the shifting condition for shifting the transmission ratio with the derailleur 22 are satisfied. The third condition includes a condition related to the speed of the human-powered vehicle 10.

In each embodiment, the electronic controller 72 can execute steps S14 and step S16 in parallel. Alternatively, the electronic controller 72 can execute step S14 after step S16.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three.

Ordinal numerals such as “first”, “second”, and “third” are used in this disclosure only to distinguish members from one another and are not intended to have a special meaning.

What is claimed is:

1. A control device for a human-powered vehicle including a crank axle configured to receive a human driving force, a first rotational body connected to the crank axle, a wheel, a second rotational body connected to the wheel, a transmission body engaged with the first rotational body and the second rotational body to transmit a driving force between the first rotational body and the second rotational body, a derailleur configured to operate the transmission body to shift a transmission ratio of a rotational speed of the wheel to a rotational speed of the crank axle, and a motor configured to drive the transmission body, the control device comprising:
an electronic controller configured to control the motor so as to drive the transmission body with the motor without propelling the human-powered vehicle with the driving force of the motor in a case where a first condition in which the crank axle is rotated and the human-powered vehicle is propelled without the human driving force and a shifting condition for shifting the transmission ratio with the derailleur are satisfied.

2. The control device according to claim 1, wherein:
the human-powered vehicle further includes a first detector that detects a parameter related to a rotational speed of the crank axle and a second detector that detects a parameter related to a rotational speed of the wheel; and
the first condition includes a condition in which the rotational speed of the crank axle obtained from the detection of the first detector is greater than zero and a condition in which the rotational speed of the crank axle is less than or equal to an estimated rotational speed calculated from the transmission ratio and the rotational speed of the wheel obtained from the detection of the second detector.

3. The control device according to claim 1, wherein:
in a case where the first condition and the shifting condition are satisfied and the motor is driven, the electronic controller is configured to stop the motor upon a stopping condition of the motor being satisfied; and
the stopping condition includes at least one of a first stopping condition in which a predetermined period elapses from when driving of the motor is started and a second stopping condition in which a load on the motor is greater than or equal to a first threshold value.

4. The control device according to claim 3, wherein
the predetermined period includes at least one of a predetermined time, a period during which an output shaft of the motor is rotated more than a first rotational angle, and a period during which the first rotational body is rotated by the motor more than a second rotational angle.

5. The control device according to claim 1, wherein:
the electronic controller is configured to control the derailleur; and
the electronic controller is configured to drive the transmission body with the motor and operate the transmission body with the derailleur in a case where the first condition and the shifting condition are satisfied.

6. The control device according to claim 5, wherein:
the electronic controller is configured to drive the transmission body with the motor without propelling the human-powered vehicle with the driving force of the motor and operate the transmission body with the derailleur in a case where a second condition and the shifting condition are satisfied; and
the second condition is satisfied in a case where rotation of the crank axle is stopped.

7. The control device according to claim 1, wherein:
the human-powered vehicle further includes a first detector that detects a parameter related to a rotational speed of the crank axle and a third detector that detects a parameter related to a human torque that is input to the crank axle of the human-powered vehicle;
the first condition is satisfied in a case where the rotational speed of the crank axle obtained from a detection value of the first detector is greater than zero and the human torque obtained from a detection value of the third detector is less than or equal to a predetermined torque; and
the predetermined torque is 0 Nm or greater and 5 Nm or less.

8. A control device for a human-powered vehicle including a crank axle configured to receive a human driving force, a first rotational body connected to the crank axle, a wheel, a second rotational body connected to the wheel, a transmission body engaged with the first rotational body and the second rotational body to transmit a driving force between the first rotational body and the second rotational body, a derailleur configured to operate the transmission body to shift a transmission ratio of a rotational speed of the wheel to a rotational speed of the crank axle, and a motor configured to drive the transmission body, the control device comprising:
an electronic controller configured to control the motor and the derailleur, and
in a case where a shifting condition for shifting the transmission ratio with the derailleur is satisfied, the electronic controller is configured to drive the transmission body with the motor without propelling the human-powered vehicle with the driving force of the motor and operate the transmission body with the derailleur to shift the transmission ratio regardless of the rotational speed of the crank axle.

9. The control device according to claim 8, wherein:
in a case where the shifting condition is satisfied and the motor is driven, the electronic controller is configured to stop driving the motor upon a stopping condition of the motor being satisfied; and
the stopping condition includes at least one of a first stopping condition in which a predetermined period elapses from when driving of the motor is started and a second stopping condition in which a load on the motor is greater than or equal to a first threshold value.

10. The control device according to claim 9, wherein
the predetermined period includes at least one of a predetermined time, a period during which an output shaft of the motor is rotated more than a first rotational angle, and a period during which the first rotational body is rotated by the motor more than a second rotational angle.

11. A control device for a human-powered vehicle including a crank axle configured to receive a human driving force, a first rotational body connected to the crank axle, a wheel, a second rotational body connected to the wheel, a transmission body engaged with the first rotational body and the second rotational body to transmit a driving force between the first rotational body and the second rotational body, a derailleur configured to operate the transmission body to shift a transmission ratio of a rotational speed of the wheel to a rotational speed of the crank axle, and a motor configured to drive the transmission body, the control device comprising:
an electronic controller configured to control the motor so as to drive the transmission body with the motor and propel the human-powered vehicle with the driving force of the motor in a case where a third condition and a shifting condition for shifting the transmission ratio with the derailleur are satisfied,
wherein the third condition includes a condition related to a speed of the human-powered vehicle.

12. The control device according to claim 11, wherein
the third condition is satisfied in a case where the speed of the human-powered vehicle is increased.

13. The control device according to claim 12, wherein:
in a case where the third condition and the shifting condition are satisfied and the motor is thereby driven to apply a propulsion force to the human-powered vehicle, the electronic controller is configured to control the motor so as to stop driving the motor upon a stopping condition being satisfied; and
the stopping condition includes at least one of a first stopping condition in which a predetermined period elapses from when driving of the motor is started and a second stopping condition in which a load on the motor is greater than or equal to a first threshold value.

14. The control device according to claim 13, wherein
the predetermined period includes at least one of a predetermined time, a period during which an output shaft of the motor is rotated more than a first rotational angle, and a period during which the first rotational body is rotated by the motor more than a second rotational angle.

15. The control device according to claim 1, wherein
the shifting condition is related to at least one of a traveling state of the human-powered vehicle, a traveling environment of the human-powered vehicle, and an operating state of a shifting device of the human-powered vehicle.

16. The control device according to claim 8, wherein
the shifting condition is related to at least one of a traveling state of the human-powered vehicle, a traveling environment of the human-powered vehicle, and an operating state of a shifting device of the human-powered vehicle.

17. The control device according to claim 11, wherein
the shifting condition is related to at least one of a traveling state of the human-powered vehicle, a traveling environment of the human-powered vehicle, and an operating state of a shifting device of the human-powered vehicle.
